(19) United States
(12) Patent Application Publication
(10) Pub. No.: US 2014/0307087 A1
(43) Pub. Date: Oct. 16, 2014

(54) METHODS AND SYSTEMS FOR PREVENTING TRAFFIC ACCIDENTS

(71) Applicant: XEROX CORPORATION, Norwalk, CT (US)

(72) Inventors: Eugene S. Evanitsky, Pittsford, NY (US); Craig Lambrecht, Rochester, NY (US)

(73) Assignee: Xerox Corporation, Norwalk, CT (US)

(21) Appl. No.: 13/860,204

(22) Filed: Apr. 10, 2013

(51) Int. Cl. G08G 1/16

(52) U.S. Cl. CPC G08G 1/164
USPC 348/143

(57) ABSTRACT

Methods and systems for preventing traffic accidents. Video can be captured from a camera integrated with a traffic light signal located at the intersection. The video can be processed to determine if an accident is likely to occur based on images contained in the vide and particular factors. Drivers of vehicles in the vicinity of the camera/traffic light can be alerted if it is determined that an accident is likely to occur, thereby allowing the drivers to take corrective action to prevent the crash from occurring.

### FIELD OF THE INVENTION

Embodiments are generally related to the traffic management and monitoring systems. Embodiments are additionally related to video cameras for monitoring traffic. Embodiments also relate to methods and systems for the prevention of vehicle accidents.

### BACKGROUND

It has been estimated that by 2020, road traffic crashes will have moved from ninth to third in the world ranking of burden of disease, as measured in disability adjusted life years. The prevention of road traffic injuries is of global public health importance. Measures aimed at reducing traffic speed are considered essential to preventing road injuries.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for methods and systems for preventing traffic accidents.

It is another aspect of the disclosed embodiments to provide for the processing of data on the fly to detect a possible accident at a traffic intersection and then take an appropriate action that may prevent the accident from occurring.

It is another aspect of the disclosed embodiments to provide for the monitoring of traffic at intersections via cameras integrated with traffic light signals.

The aforementioned aspects and other objectives and advantages can now be achieved as described herein. Methods and systems for preventing traffic accidents are disclosed. Video can be captured from a camera integrated with a traffic light signal located at the intersection. The video can be processed to determine if an accident is likely to occur based on images contained in the video and particular factors. Drivers of vehicles in the vicinity of the camera/traffic light can be alerted if it is determined that an accident is likely to occur, thereby allowing drivers or pedestrians to take corrective action to prevent the accident from occurring.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a system for preventing traffic accidents in accordance with a preferred embodiment;

FIG. 2 illustrates a block diagram of a system for preventing traffic accidents, in accordance with an alternative embodiment;

FIG. 3 illustrates a high-level flow chart depicting logical operational steps of a method for preventing traffic accidents in accordance with an alternative embodiment; and

FIG. 4 illustrates a schematic representation of a processing system that can be adapted for use in accordance with one or more embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein: rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

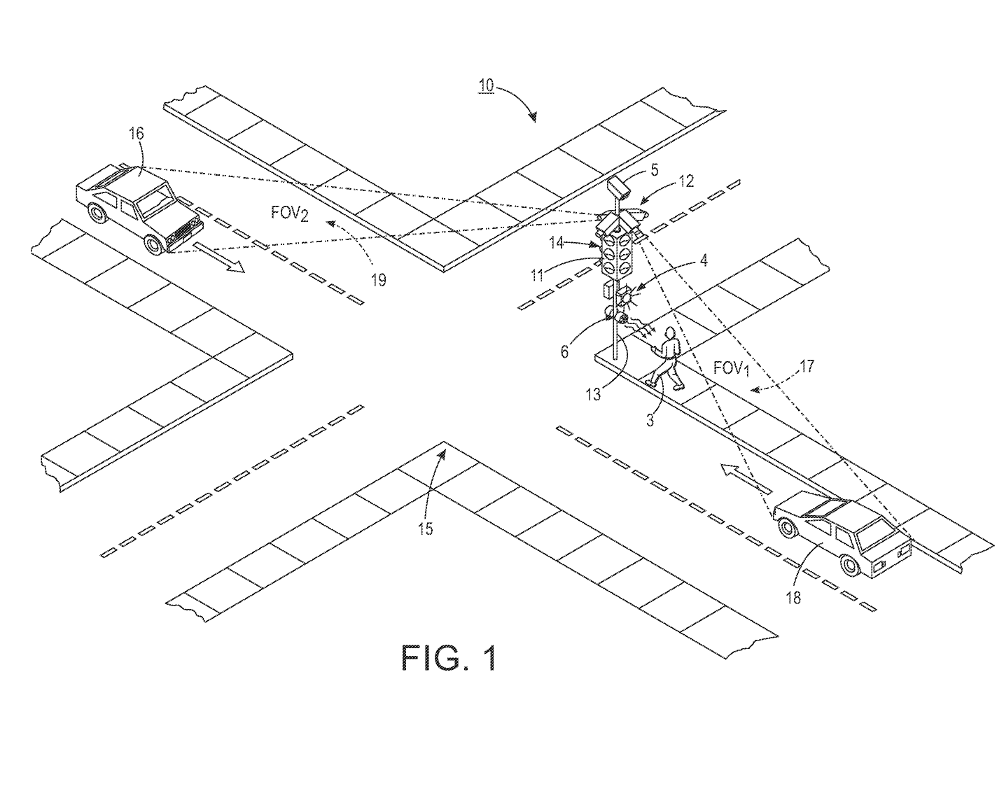

FIG. 1 illustrates a schematic diagram of a system 10 for preventing traffic accidents in accordance with a preferred embodiment. The system 10 generally includes one or more cameras 12 that can be integrated or associated with a traffic light 11 located at a traffic intersection 15 in, for example, a single unit 14 and mounted on a pole 13. It can be appreciated that multiple traffic lights and cameras may be located at the intersection 15, but only a camera/traffic light unit 14 is shown in FIG. 1 for illustrative purposes only. In the example shown in FIG. 1, four cameras 12 are shown in the configuration of FIG. 1, but additional or few cameras may be utilized depending upon design considerations and goals

The camera/light unit 14 can record events along with vehicle information and may shoot still pictures or video, including recording and live video. The camera may have a first field of view (FOV₁) 17 with respect to one direction and a second field of view (FOV₂) in another direction. The system 10 can be configured to use live video captured by camera 12 integrated with traffic light 11 to determine if an accident is likely to occur and then take appropriate action to prevent the accident from occurring.

System 10 can also incorporate, in some embodiments, one or more radar detectors such as radar detector 5. The technology for determining speed can rely entirely on imaging techniques or the unit 14 can be configured to include a radar detector in lieu of or in association with cameras 12, etc.

Note that in FIG. 1 at least one or more of the cameras 12 is shown pointing at the intersecting street. An accident is most likely to occur with a vehicle crossing through the intersection than it is with an approaching vehicle. A pedestrian 3 is also shown in FIG. 1. Pedestrians may not see a turning car and the driver may not see the pedestrian in the same situation. Thus, system 10 can be utilized to alert not only drivers of potential accidents, but also pedestrians such as pedestrian 3 shown in FIG. 1.

System 10 can detect situations that are likely to result in an accident and take some corrective action to alert drivers of vehicles such as, for example, vehicles 16, 18 shown in FIG. 1 in order to prevent such an accident from occurring. In such a system, data is processed very quickly and actions taken with enough time for drivers to become aware and to react. All this must take place within seconds, as will be explained in more detail shortly. As shown in FIG. 1, the camera/light unit 14 can communicate with a strobe light 4 and/or a speaker 6, which can be utilized to alert drivers of potential traffic accidents. Note that the strobe light 4, speaker 6, radar detector 5, etc., can be mounted on the pole 13 that supports the traffic light 14.

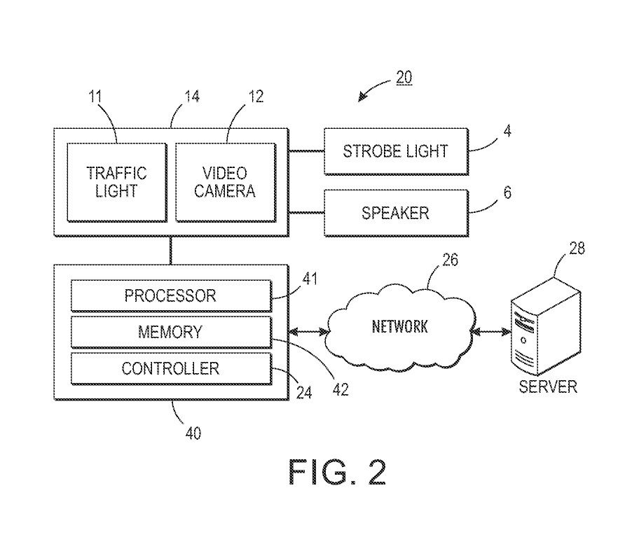

FIG. 2 illustrates a block diagram of a system 20 for preventing traffic accidents, in accordance with an alternative embodiment. Note that the processing of information to determine if an accident is imminent can take place within the system that contains the traffic light, and cameras, etc., or it can occur in the “cloud” using banks of processors. Either embodiment is feasible.

System 20 generally includes one or more traffic lights such as traffic light 11 integrated with one or more video cameras such as camera 12 integrated into one or more units such as camera/traffic light unit 14. The unit 14 can communicate with a processing system 40 that includes, for example, a processor 41, a memory 42, and a controller 24. The processing system 40 can in turn communicate with a network (e.g., the Internet), which in turn communicates with a server 28. The unit 14 can also communicate with a high intensity strobe light 4 and/or a speaker system 6. Software can thus process images in real time captured by the camera 12 and which also controls via, for example, controller 24, the traffic light 11, and camera 12.

System 20 thus permits monitoring of the speeds of approaching vehicles such as vehicles 16, 18 shown in FIG. 1 and whether such vehicles are accelerating or decelerating. The speeds of approaching vehicles can be matched with the timing of the traffic light 11 to determine if the vehicle or vehicles are likely to run a red or flashing traffic signals. The speed of a vehicle or vehicles approaching from another direction can also be compared to other approach vehicles to determine if a collision is likely to occur. Car movement and other indicators such as a turning signals and environmental conditions can also be monitored to determine if, for example, a turning vehicle is not stopping and an accident is likely. System 20 can also observe pedestrians or children about to move into a cross walk, and identify cars with blind stops (e.g., a car behind a truck (obscuring vision), in a turn only lane that may follow the truck through the intersection which may be clear for the truck by not the next car in line).

System 20 can be employed to prevent accidents in a number of ways. For example, system 20 can bring people's attention to dangerous conditions so they can stop. This can be accomplished by use of, for example, speaker 6, which produces an audible alert to everyone in the vicinity of a danger, similar to a fire truck alarm (e.g., we would not want only one person to stop; we want everyone to stop until the danger clears). Another option involves making use of a high intensity strobe light 4 to emit a rapid sequence of strobe flashes that can indicate immediate danger. Another option would be to hold the “red” light longer (i.e., this can be thought of as holding the green light or yellow light longer since the lights are coordinated) if it is clear that someone is going to run through the red light from another direction.

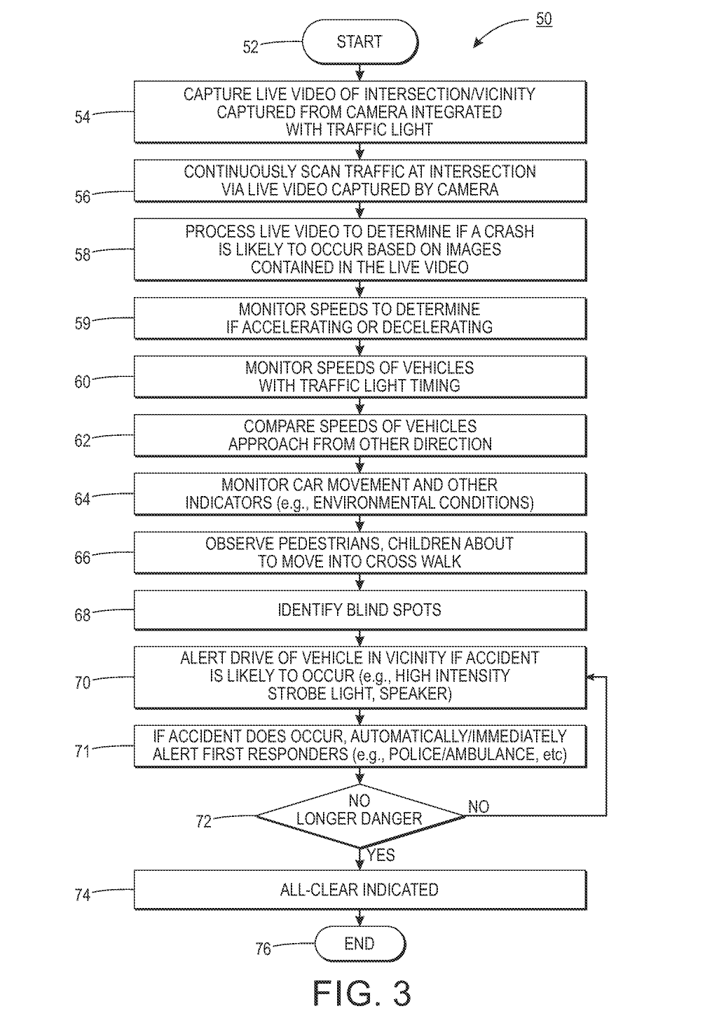

FIG. 3 illustrates a high-level flow chart depicting logical operational steps of a method 50 for preventing traffic accidents in accordance with an alternative embodiment. As indicated at block 52, the process can begin. Then, as depicted at block 54, live video of an intersection and/or the intersection vicinity can be captured from, for example, one or more cameras such as camera 12, which is integrated with traffic light 11. Next, as shown at block 56, a step or logical operation can be implemented to continuously scan traffic at the intersection via the live video captured by the camera 11. The live video can be processed as depicted at block 58 to determine if an accident is likely to occur based on the images contained in the live video.

The operation shown at block 58 can involve monitoring of various parameters and factors, examples of which are shown in blocks 60, 62, 64, 66, and 68 to name a few. For example, as described at block 59, a step or logical operation can be implemented to monitor the speeds of approaching vehicles and whether they are accelerating or decelerating. As shown next at block 60, a step or logical operation can be implemented for matching the speeds of vehicles with traffic light timing to determine if a vehicle is likely to run a red or flashing traffic signal. As depicted at block 62, a step or logical operation can be implemented to compare the speeds of vehicles approaching from another direction to determine if a collision may occur. As illustrated at block 64, a step or logical operation can be implemented to monitor car movement and other indicators (e.g., turning signals to determine if a turning vehicle is not stopping and an accident is likely) and other indicators (e.g., environmental conditions). That is, the logic of method 50 for determining if an accident is likely can factor in environmental conditions such as rain, snow, fog, icy roads, hours of darkness, school in session, etc.

Other monitoring operations can also be implemented. For example, as shown at block 66, a step or logical operation can be implemented to observe pedestrians or children about to move into a cross walk. As depicted at block 68, a step or logical operation can be implemented to identify cars with blind spots (e.g., a car behind a truck (obscuring vision), in a turn only lane that may follow the truck through the intersection which may be clear for the truck by not the next vehicle in line). Once such conditions have been monitored/processed, an alert can be given, as shown at block 70, to indicate to drivers that an accident is likely to occur. As shown next at block 71 if an accident does occur, then first responders (e.g., police, ambulance services, etc.) can be automatically alerted.

Following processing of the operation at block 71, operations can be implemented for when and how an alert should be turned off. That is, when the logic determines that there is no longer a danger, an “all clear” can be indicated by a special sound and/or strobe light dimming and then turned off. So, for example, as shown at decision block 72, a test can be performed to determine if there is no longer a danger. If the danger is over (“YES”) then as shown as block 74, an “all clear” can be indicated with a special sounds and/or strobe light dimming and then turned off. The process can then terminate as shown at block 76. If it is determined that the danger is not over, then the process shown at blocks 70, 71, etc., can be repeated until the danger is determined to have ended.

The traffic accident prevention system and/or method discussed herein can be implemented in hardware circuits, and/or some parts can be implemented in software in any computer language, run by conventional processing hardware such as a general purpose microprocessor, or application specific integrated circuits for example.

For example, such methods and/or systems may be implemented as a controller and can be implemented as hardware, computer software, or combinations of both. Such a controller may include a general purpose processor, an embedded processor, an application specific integrated circuit (ASIC), a field programmable gate array (FPGA) or other programmable logic device, discrete gate or transistor logic, discrete hardware components, or any combination designed to perform the functions described herein. A processor may also be implemented as a combination of computing devices, e.g., a combination of a FPGA and a microprocessor, a plurality of microprocessors, one or more microprocessors in conjunction with a FPGA, or any other such configuration. Note that as indicated previously, the processing of information to determine if an accident is imminent can take place within the system that contains the traffic light, and cameras, etc., or it can occur in the “cloud” using banks of processors. Either embodiment is feasible.

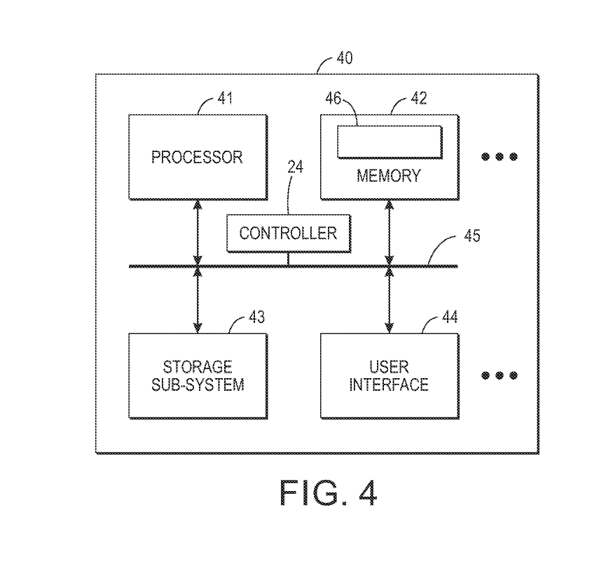

Embodiments can also be realized via a processor system. Such a processing system may include a computing device or processing engine, e.g., a microprocessor, a server, etc. Any of the methods described above according to embodiments of the present invention or claimed may be implemented in, for example, a processing system 40 such as shown in FIG. 4. FIG. 4 shows one possible configuration of processing system 40 that includes at least one customizable or programmable processor 41 coupled to a memory subsystem 42 that includes at least one form of memory, e.g., RAM, ROM, and so forth. It is to be noted that the processor 41 or processors may be a general purpose, or a special purpose processor, and may be for inclusion in a device, e.g., a chip that has other components that perform other functions.

Thus, one or more aspects of the method according to embodiments of the present invention can be implemented in digital electronic circuitry, or in computer hardware, firmware, software, or in combinations of them. The processing system may include a storage subsystem 43 that has at least one disk drive and/or CD-ROM drive and/or DVD drive. In some cases, storage subsystem 43 may include, for example, a USB drive or a port for access to a USB storage drive or Flash drive. In some implementations, a display system, a keyboard, and a pointing device may be included as part of a user interface 44 to provide for a user to manually input information such as parameter values. An example of such a user interface is a GUI (Graphical User Interface). Ports for inputting and outputting data may be included.

More elements such as network connections, interfaces to various devices, and so forth, may be included, but are not illustrated in FIG. 4. The various elements of the processing system 40 may be coupled in various ways, including via a bus subsystem 45 shown in FIG. 4 for simplicity as a single bus, but which will be understood to those in the art to include a system of at least one bus. The memory of the memory subsystem 42 may at some time hold part or all of a set of instructions that when executed on the processing system 40 implement the steps of the method embodiments described herein. A module 46 (e.g., a software module) stored within memory 42 may contain such instructions. For example, module 46 may contain instructions for carrying out the various steps or logical operations shown in the various blocks of FIG. 3.

Embodiments can also include a computer program product, which provides the functionality of any of the methods according to the present invention when executed on a computing device such as a processing engine. Software according to the present invention, when executed on a processing engine, can contain code segments that provide, for example, software and instructions thereof for carrying out the steps or logical operations shown in FIG. 3 and operations with respect to the various components shown in FIG. 2.

Such a computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks such as a storage device, which is part of mass storage. Common forms of computer readable media include a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network such as a LAN, a WAN or the Internet. Transmission media can take the form of acoustic or light waves such as those generated during radio wave and infrared data communications. Transmission media include coaxial cables, copper wire, and fiber optics, including the wires that comprise a bus within a computer.

The embodiments disclosed herein offer a number of advantages. For example, the disclosed system and method will reduce traffic fatalities and injuries. Insurance companies would find such a system valuable. Medical costs and lawsuits/settlement typically results in millions of dollars in costs to insurance companies. If such a system and/or method could reduce the number of accidents by even 0.1%, this would have a significant financial impact. Insurance companies and municipalities, for example, may actually provide the funding for implementing the approach described herein.

Based on the foregoing, it can be appreciated that a number of embodiments are disclosed herein. For example, in one potential embodiment, a method can be implemented for preventing traffic accidents. Such a method can include the steps or logical operations of, for example, capturing live video from at least one camera integrated with at least one traffic light signal located at an intersection, processing the live video to determine if an accident is likely to occur based on images contained in the live video, and alerting at least one driver of at least one vehicle and/or at least one pedestrian in a vicinity of the at least camera and the at least one traffic light that the accident is likely to occur and to take corrective action to prevent the accident from occurring.

In another embodiment, a step or logical operation can be implemented for continuously scanning traffic at the intersection via the live video captured from the at least one camera integrated with the at least one traffic light. In yet another embodiment, the at least one camera can be integrated with at least one traffic light signal that is associated with a high intensity strobe light for alerting the at least one driver. In other embodiments, the at least one camera can be integrated with at least one traffic light signal that is associated with a speaker system for alerting the at least one driver.

In another embodiment, steps or logical operations can be provided for processing live images from the live video in real time and controlling the at least one traffic light based on processing the live images from the live video in real time. In still another embodiment, a step or logical operation can be provided for monitoring a speed of approaching vehicles shown in the live video and determining if the vehicles are accelerating or decelerating.

In another embodiment, a step or logical operation can be provided for matching the speed of the approaching vehicles with traffic light timing associated with the at least one traffic light to determine if the approaching vehicles are likely to run a red light or a flashing traffic signal. In yet another embodiment, a step or logical operation can be provided for comparing speeds of the approaching vehicles versus vehicles shown in the live video approaching from another direction to determine if a collision is likely to occur.

In another embodiment, a step or logical operation can be provided for automatically overriding a traffic signal changing mechanism associated with the at least one traffic light to maintain a red light thereof for a longer period of time with a respect to the at least one vehicle if the at least one vehicle is in danger of being struck by another vehicle running the red light. In still another embodiment, a step or logical operation can be provided for processing radar detection data with respect to the at least one vehicle to determine a speed of the at least one vehicle and factor in the speed to determine if the accident is likely to occur.

In other embodiments, a system for preventing traffic accidents can be provided. Such a system can include, for example, a processor, a data bus coupled to the processor, and a computer-usable medium embodying computer program code, the computer-usable medium being coupled, for example, to the data bus. Such computer program code can include instructions executable by the processor and configured, for example, for capturing live video from at least one camera integrated with at least one traffic light signal located at an intersection, processing the live video to determine if an accident is likely to occur based on images contained in the live video; and alerting at least one driver of at least one vehicle and/or at least one pedestrian in a vicinity of the at least camera and the at least one traffic light that the accident is likely to occur and to take corrective action to prevent the accident from occurring.

In some embodiments, such instructions can be further configured for continuously scanning traffic at the intersection via the live video captured from the at least one camera integrated with the at least one traffic light. In still other embodiments, the at least one camera can be integrated with at least one traffic light signal that is associated with a high intensity strobe light for alerting the at least one driver and/or with a speaker system for alerting the at least one driver.

In yet other embodiments, the instructions can be further configured for processing live images from the live video in real time and controlling the at least one traffic light based on processing the live images from the live video in real time. In some embodiments, such instructions can be further configured for monitoring a speed of approaching vehicles shown in the live video and determining if the vehicles are accelerating or decelerating. In other embodiments, such instructions can be further configured for matching the speed of the approaching vehicles with traffic light timing associated with the at least one traffic light to determine if the approaching vehicles are likely to run a red light or a flashing traffic signal. In yet other embodiments, such instructions can be further configured for comparing speeds of the approaching vehicles versus vehicles shown in the live video approaching from another direction to determine if a collision is likely to occur.

In still other embodiments, such instructions can be further configured for automatically overriding a traffic signal changing mechanism associated with the at least one traffic light to maintain a red light thereof for a longer period of time with respect to the at least one vehicle if the at least one vehicle is in danger of being struck by another vehicle running the red light. In other embodiments, such instructions can be further configured for processing radar detection data with respect to the at least one vehicle to determine a speed of the at least one vehicle and factor in the speed to determine if the accident is likely to occur.

In yet another embodiment, a processor-readable medium storing computer code representing instructions to cause a process for preventing traffic accidents can be implemented. Such computer code include code to, for example: capture live video from at least one camera integrated with at least one traffic light signal located at an intersection; process the live video to determine if an accident is likely to occur based on images contained in the live video; and alert at least one driver of at least one vehicle and/or at least one pedestrian in a vicinity of the at least camera and the at least one traffic light that the accident is likely to occur and to take corrective action to prevent the accident from occurring.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for preventing traffic accidents, said method comprising:
capturing live video from at least one camera integrated with at least one traffic light signal located at an intersection;
processing said live video to determine if an accident is likely to occur based on images contained in said live video; and
alerting at least one driver of at least one vehicle and/or at least one pedestrian in a vicinity of said at least camera and said at least one traffic light that said accident is likely to occur and to take corrective action to prevent said accident from occurring.

2. The method of claim 1 further comprising continuously scanning traffic at said intersection via said live video captured from said at least one camera integrated with said at least one traffic light.

3. The method of claim 1 wherein said at least one camera integrated with at least one traffic light signal is associated with a high intensity strobe light for alerting said at least one driver.

4. The method of claim 1 wherein said at least one camera integrated with at least one traffic light signal is associated with a speaker system for alerting said at least one driver.

5. The method of claim 1 further comprising:
processing live images from said live video in real time; and
controlling said at least one traffic light based on processing said live images from said live video in real time.

6. The method of claim 5 further comprising monitoring a speed of approaching vehicles shown in said live video and determining if said vehicles are accelerating or decelerating.

7. The method of claim 6 further comprising matching said speed of said approaching vehicles with traffic light timing associated with said at least one traffic light to determine if said approaching vehicles are likely to run a red light or a flashing traffic signal.

8. The method of claim 6 further comprising comparing speeds of said approaching vehicles versus vehicles shown in said live video approaching from another direction to determine if a collision is likely to occur.

9. The method of claim 6 further comprising automatically overriding a traffic signal changing mechanism associated with said at least one traffic light to maintain a red light thereof for a longer period of time with a respect to said at least one vehicle if said at least one vehicle is in danger of being struck by another vehicle running said red light.

10. The method of claim 1 further comprising processing radar detection data with respect to said at least one vehicle to determine a speed of said at least one vehicle and factor in said speed to determine if said accident is likely to occur.

11. A system for preventing traffic accidents, said system comprising:
a processor;
a data bus coupled to said processor; and
a computer-usable medium embodying computer program code, said computer-usable medium being coupled to said data bus, said computer program code comprising instructions executable by said processor and configured for:
capturing live video from at least one camera integrated with at least one traffic light signal located at an intersection;
processing said live video to determine if an accident is likely to occur based on images contained in said live video; and
alerting at least one driver of at least one vehicle and/or at least one pedestrian in a vicinity of said at least camera and said at least one traffic light that said accident is likely to occur and to take corrective action to prevent said accident from occurring.

12. The system of claim 11 wherein said instructions are further configured for continuously scanning traffic at said intersection via said live video captured from said at least one camera integrated with said at least one traffic light.

13. The system of claim 11 wherein said at least one camera integrated with at least one traffic light signal is associated with a high intensity strobe light for alerting said at least one driver and/or with a speaker system for alerting said at least one driver.

14. The system of claim 11 wherein said instructions are further configured for:
processing live images from said live video in real time; and
controlling said at least one traffic light based on processing said live images from said live video in real time.

15. The system of claim 14 wherein said instructions are further configured for monitoring a speed of approaching vehicles shown in said live video and determining if said vehicles are accelerating or decelerating.

16. The system of claim 15 wherein said instructions are further configured for matching said speed of said approaching vehicles with traffic light timing associated with said at least one traffic light to determine if said approaching vehicles are likely to run a red light or a flashing traffic signal.

17. The system of claim 16 wherein said instructions are further configured for comparing speeds of said approaching vehicles versus vehicles shown in said live video approaching from another direction to determine if a collision is likely to occur.

18. The system of claim 16 wherein said instructions are further configured for automatically overriding a traffic signal changing mechanism associated with said at least one traffic light to maintain a red light thereof for a longer period of time with respect to said at least one vehicle if said at least one vehicle is in danger of being struck by another vehicle running said red light.

19. The system of claim 11 wherein said instructions are further configured for processing radar detection data with respect to said at least one vehicle to determine a speed of said at least one vehicle and factor in said speed to determine if said accident is likely to occur.

20. A processor-readable medium storing computer code representing instructions to cause a process for preventing traffic accidents, said computer code comprising code to:
capture live video from at least one camera integrated with at least one traffic light signal located at an intersection;
process said live video to determine if an accident is likely to occur based on images contained in said live video; and
alert at least one driver of at least one vehicle and/or at least one pedestrian in a vicinity of said at least camera and said at least one traffic light that said accident is likely to occur and to take corrective action to prevent said accident from occurring.
